(19) United States
(12) Patent Application Publication
(10) Pub. No.: US 2006/0262776 A1
(43) Pub. Date: Nov. 23, 2006

(54) System and method for auto-discovery of peering and routing in a combined circuit -switched/packet-switched communication network using trip protocol

(76) Inventor: Graham S. Pollock, Folsom, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/135,132

(22) Filed: May 23, 2005

(51) Int. Cl. H04L 12/66

(52) U.S. Cl. 370/352; 370/401

(57) ABSTRACT

In one embodiment, the information required for routing between IP Telephony Administration Domains (ITADs) is gathered automatically by a location server which operates in the listen-only mode and which is peered with a TRIP inter-domain protocol. The peered location server uses the TRIP protocol to discover routing information thereby allowing for the automatic updating of route data for both internal and external telephony routes. In one embodiment, the peered router maintains an up-to-date picture of the service provider's routing and time stamps the colleted data, thereby allowing for the collection and utilization of historical TRIP performance information. Based on such a historical analysis, the service provider can keep track of, for example, its most reliable peers, peering routes, unstable routes, unavailable routes, etc.

### RELATED APPLICATIONS

The present application is related to commonly assigned European Patent Application Number EP 1387 527A, entitled “IDENTIFYING NETWORK ROUTERS AND PATHS,” dated Apr. 2, 2004. The present application is also related to concurrently filed and commonly assigned U.S. patent applications Ser. No. ______ [Attorney Docket Number 10041164-1] entitled “SYSTEM AND METHOD FOR AUTO-DISCOVERY OF PEERING AND ROUTING IN A COMBINED CIRCUIT-SWITCHED/PACKET-SWITCHED COMMUNICATION NETWORK USING SNMP,” the disclosures of which are hereby incorporated herein by reference.

### TECHNICAL FILED

This invention relates to combined circuit-switch/packet-switched telephone networks and more specifically to dynamically establishing routing and peering arrangements among telephone termination points.

### BACKGROUND OF THE INVENTION

Traditional telecommunication service providers are in the process of migrating their existing communications traffic from circuit-switched networks (e.g. the GSTN) to packet switched networks (e.g. IP networks). However, the transition from circuit to packet-based networks is likely to take a significant amount of time due mainly to the large amount of investment in the current infrastructure. During the transition period, there is a need to allow customers using either technology to communicate with each other. For example, an existing GSTN customer may wish to place a voice call to a customer with an internet phone, using the Voice Internet Protocol (VoIP) phone connected to their Cable provider, or vise versa.

In order for this communication to take place, inter-working devices known as media gateways are used to interface between the circuit-based and packet-based worlds. Media gateways are responsible for terminating circuit-based trunks that handle calls originating from the GSTN and translating the content into Real-Time Transport Protocol (RTP) streams that can be passed across Internet Protocol (IP) networks, either for direct delivery to IP-based terminal devices, or to other Media Gateways that in turn convert the RTP stream back into a GSTN call. Media Gateways can also translate IP-originated calls that are destined for GSTN customers.

Service providers need to share information regarding the reachability of these Media Gateways, and the customers that are accessible from them if they are to be able to correctly route calls between the GSTN and IP-based networks. The Internet Engineering Task Force (IETF) has defined a protocol known as Telephony Routing Over IP (TRIP), defined in RFC 3219 Request For Comments, January 2002, which document is hereby incorporated by reference herein (portions of which are included in Appendix A hereof), to help automate this sharing of telephony routing and media gateway knowledge. In addition, work is ongoing within the IETF to establish a Simple Network Management Protocol (SNMP) Management Information Base (MIB) for TRIP-capable devices for network management purposes, as shown in RFC 3872 Request For Comments, September 2004, which document is hereby incorporated by reference herein. These protocols are designed for routing control but do not address tracking of the network so that the network can determine, at any point in time, the health and stability of the network or whether additional resources, or other call routes must be established.

One method for communicating telephony routing information among networks is to manually gather the information for dissemination. However, such a manual approach introduces the possibility for human error in the process and could lead to inaccurate collection and dissemination of peering information, potentially leading to the inability for groups of GSTN customers to communicate with IP customers or vise versa. This could lead to loss of revenue, and ultimately to increased customer “dissatisfaction” if the problem is not dealt with effectively. Adding to the problem of using a manual process is the problem that correlating the raw data together by hand increases the likelihood of manual error. Ultimately the timescales involved, or the number of errors introduced by a manual process, would limit the scalability and flexibility of such an approach.

### BRIEF SUMMARY OF THE INVENTION

In one embodiment, the information required for routing between IP Telephony Administration Domains (ITADs) is gathered automatically by a location server which operates in the listen-only mode and which is peered with a TRIP inter-domain protocol. The peered location server uses the TRIP protocol to discover routing information thereby allowing for the automatic updating of route data for both internal and external telephony routes. In one embodiment, the peered router maintains an up-to-date picture of the service provider's routing and time stamps the colleted data, thereby allowing for the collection and utilization of historical TRIP performance information. Based on such a historical analysis, the service provider can keep track of, for example, its most reliable peers, peering routes, unstable routes, unavailable routes, etc.

### BRIEF DESCRIPTION OF THE DRAWINGS

For a more complete understanding of the present invention, reference is now made to the following descriptions taken in conjunction with the accompanying drawings, in which:

FIG. 1 shows one embodiment of a system using the concepts of the invention; and

FIG. 2 shows a flow diagram of one embodiment of a process for control of the invention.

### DETAILED DESCRIPTION OF THE INVENTION

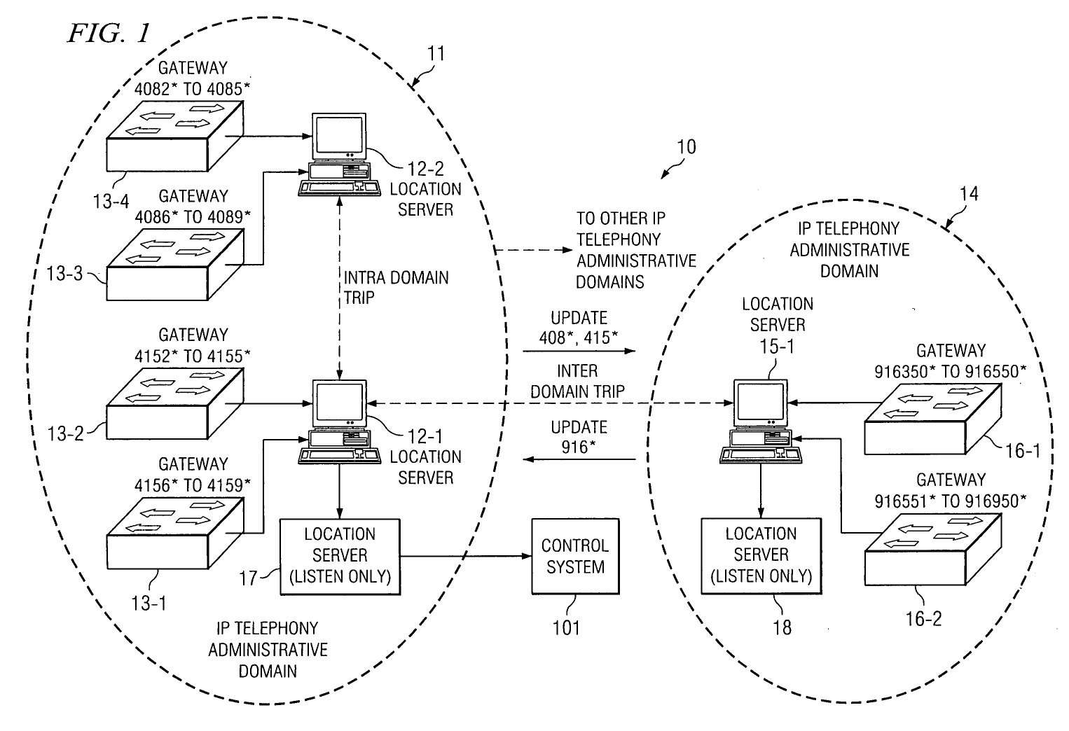

FIG. 1 shows one embodiment 10 of a system using the concepts of the invention for tracking changes in routing between two IP Telephony Administrative Domains (ITADs). Embodiment 10 shows two ITADs interconnected for the purpose of communicating data from one to another so that each ITAD knows how to route information to reach destinations in the other ITAD. Circuit switched lines are terminated on gateways such as, gateway 13-1 through 13-4 (GW1-GW4) in ITAD 11.

In the embodiment shown, gateway 13-1 terminates all circuit switch calls that have the seven digits between area code 415-600-0000 to 415-999-9999 similarly gateway 13-4 handles circuit switch lines with telephone numbers between 408-200-0000 to 408-599-9999. Likewise, in ITAD 14 gateway 16-1 handles calls to circuit switched telephone numbers 916-350-0000 to 916-550-9999. Thus, a call coming through ITAD 14 directed to, for example, phone number 415-600-1234, would have to be directed to gateway 13-1 in ITAD 11.

Location servers in each ITAD, such as location servers 12-1 and 12-2 in ITAD 11 or location server 15-1 in ITAD 14, must know that the desired telephone number 415-600-1234 is served out of ITAD 11. In order for location server 15-1 to have this information it must receive information from location server 12-1 in ITAD 11. This is accomplished through the inter-domain use of the TRIP protocol.

In accordance with the TRIP architecture, a service provider will divide their service area into one or more ITADs that act as independent entities with regard to the management and control of telephony peering and routing within the service provider's area of operation. The TRIP protocol is based upon the Border Gateway Protocol (BGP). However, unlike BGP, full mesh topologies or those involving route reflectors are not required.

As discussed, the TRIP protocol is set-out in a network working group paper dated Jan. 2002 which paper bears a copyright notice by the Internet Society (2002). Appendix A to this application contains portions of that document relevant to an understanding of the disclosure of the inventive concept contained in this application.

In operation, location server 12-1 in ITAD 11 uses the inter domain TRIP to update location server 15-1 in ITAD 14 with respect to the phone numbers served by gateways 13-1 through 13-4 within ITAD 11. Thus, if for example, if some portion of the phone number served by gateway 13-1 were to be moved to a different location server, or if the gateway became unavailable or taken off line for any reason, that information would be provided via inter domain TRIP to Location server 15-1. In similar manner, location server 15-1 in ITAD 14 would transmit inter domain TRIP messages to location server 12-1 in ITAD 11 pertaining to updates with respect to those portions of the 916 area code serviced by ITAD 14. Under the TRIP protocol LS 12-2 updates (and is updated by) LS 12-1. See, for example, Appendix A, page 14.

In accordance with one embodiment of the invention, there is also located in at least one ITAD, such as ITAD 11 and/or ITAD 14, location servers 17 and 18, respectively. These location servers are designed to be listen-only (in accordance with the TRIP protocol. See, for example, Appendix A, page 14) such that they listen to the updates sent out from location server 12-1 and updates incoming to 12-1, so that location server 17, while remaining silent with respect to Inter Domain communications, serves to maintain an accurate real-time listing of each of the locations for the respective gateways for telephone numbers served by ITAD 11. Likewise, location server 18 (if provided) performs the same function with respect to ITAD 14, keeping track of the latest transactions so that an accurate list can be maintained of the current topology of the network as seen by ITAD 14. Each of the entries in the listen-only location server can be, if desired, time coded so that a backward search can be made to determine the status of the network at any given time, or over a period of a given time. Control system 101 can be used to collect the stored information for network tracking purposes.

Using the information stored in LS 17 (and/or LS 18) the control system is able to work out information such as which are the most reliable location servers in the network, which LS is announcing the most routes, which is removing the most routes, etc. None of this information is carried directly in the protocol, and it is inferred by the listener.

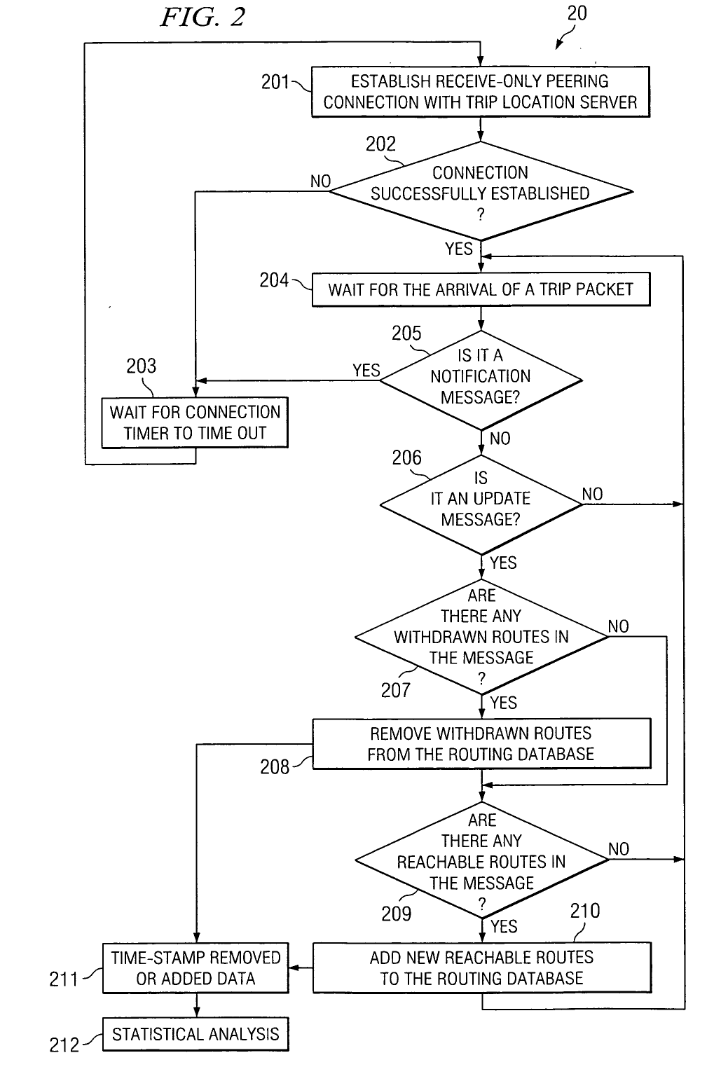

Turning now to FIG. 2, there is shown one embodiment 20 of a flow diagram showing process control. Thus, process 201 establishes a receiving-only peer connection with the TRIP location server at the domain it is monitoring. In this case, with respect to ITAD 11, location server 17 (FIG. 1) establishes a TRIP peering session with location server 12-1.

Process 202 determines if a connection is successfully established. If not, process 203 times out and reestablishment will be undertaken again via Process 201.

Process 204 waits for the arrival of a TRIP packet. If a TRIP packet is a notification message, then the system again times out via process 203 and process as 201, 202, and 204 are repeated. This is done because notification messages are an indication of an error condition in the TRIP protocol, and require the peers to disconnect.

If the TRIP packet is not a notification message, (process 205), then process 206 determines if the packet is an UPDATE message. If an update message is received then process 207 determines if there are any withdrawn routes in the message, and updates the set of operational statistics maintained by the read-only server. Process 208 removes any withdrawn routes from the routing database and process 211 time stamps the removed route data. Process 209 then determines if there are any reachable routes (newly added routes) in the message. If there are none, then the system waits for a new TRIP message 204. If there is a reachable route in the message, meaning that a new route has been added, then the new route is added to the routing database via process 210, and again process 211 time stamps the added data. Process 212 gathers the data from storage from time to time, and the set of operational statistics maintained by the read-only location server is updated. Some of the statistics that can be calculated are availability/unavailability of routes, gateways, and location servers. Each of these entities can either be “available” or “unavailable”. By recording how much time is spent in each state since the last time they transitioned between states, and overall since measuring started, there are four possible measurements for each entity, leading to 12 total measurements for all three entities. Examples of the four measurements for a gateway are: route availability since last state transition, route availability overall, route unavailability since the last state transition, and overall route unavailability.

To help clarify these measurements, take the following example. Imagine a monitoring system which observes a route for the 408 area code first being made available at 12:00 p.m., removed at 1:00 p.m., and then reinstated at 2:00 p.m. If the four availability/unavailability measurements are made at 4:00 p.m., the following results will be calculated; 408 route availability since last transition=2 hours, 408 overall route availability=3 hours, 408 route unavailability since last transition=0 hours, 408 route unavailability overall=1 hour.

A gateway would be assumed to be unavailable when all of its associated routes are withdrawn. Location server availability/unavailability can be computed by observing the ITAD topology attributes in TRIP UPDATE message.

Reliability of routes, gateways, and location servers: If the overall availability of an entity is divided by the sum of the time it was available and unavailable, a measure of the percentage of the time that it was available is obtained. This is a measure of its reliability. Similarly, the overall unavailability of an entity divided by the sum of the time it was available and unavailable yields the percentage of the time that it was unavailable. This is a measure of its unreliability. This leads to a total of six measurements for the three entities route, gateway, and location server. Using the previous example, a calculation can be made of the availability for the 408 route at 4:00 p.m. to be 75%, and the unavailability to be 25%.

Gateway and location servers announcing the most newly added routes: There are two variants on this measurement; an absolute version counting the number of added routes since the measurement system started, and a relative version counting the number of additions in a specific time interval (e.g., per hour). This leads to four measurements, two each for gateways, and location servers.

Rate of route additions per gateway and location server: By taking the derivative of the relative form of the added routes measurement, it is possible to compute the rate of change in the addition of routes to both gateways and location servers. This leads to a total of two new measurements.

Gateway and location servers announcing the most removed routes: There are two variants on this measurement; an absolute version counting the number of removed routes since the measurement system started, and a relative version counting the number of removals in a specific time interval (e.g., per hour). This leads to four measurements, two each for gateways, and locations servers.

Rate of route removals per gateway and location server: By taking the derivative of the relative form of the removed routes measurement, it is possible to compute the rate of change in the removal of routes from both gateways and location servers. This leads to a total of two new measurements.

The process then waits for the arrival of the next TRIP packet via process 204. These processes continue such that the listen-only location server, such as location server 17 in ITAD 11, at all times maintains a “photograph” of the routing being used by location server 12-1.

Data complied by location server 17 can be downloaded, or read by, control system 101 for maintenance purposes or for real-time control or tracking of the network. Control system 101 can be local to ITAD 11, serving only ITAD 11, or it can, if desired, serve several ITADs (connected together by wireline or wirelessly, not shown) or control system 101 can be located external to all ITADs serving one or more of them. Control 101 can be part of LS 17, if desired.

Basing the network discovery mechanism of the peered listen-only location server on the TRIP architecture and SNMP also limits the number of probes required to discover a service provider's media gateway peering configuration, since only one probe is required per ITAD. This probe need only query with one of the LSs in the ITAD to discover the entire peering configuration for that ITAD.

In addition, the discovery mechanism is independent of the particular signaling protocol used within the service provider (e.g. H.323 or SIP), to control the voice calls being made, meaning that the same probe can be used in networks with multiple signaling protocols.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A communication system in which communications between circuit-switched and packet-switched terminations are interchangeably processed, said system comprising:
at least one ITAD for handling connections to and from a certain set of terminations;
a plurality of gateways serving terminations within said ITAD;
at least one location server for communicating with said gateways at said ITAD, said location server providing inter-ITAD telephony routing information for said gateways, said location server bi-directionally communicating with a second ITAD in a peering session using a defined protocol to both supply said second ITAD with routing information pertaining to gateways serving said ITAD and to receive said telephony routing information from said second ITAD pertaining to gateways serving said second ITAD;
a monitoring location server associated with said ITAD for peering unidirectionally with said location server at said same ITAD using said defined protocol, said peering causing telephony routing data passing between said location servers at said ITADs to also be communicated to said monitoring location server;
a time stamp for identifying changing telephony routing data; and
a control system for performing analytical measurements using said time stamped data.

2. The communication system of claim 1 wherein said analytical measurement comprises:
availability/unavailability of at least one of the following:
routes, gateways or location servers.

3. The communication system of claim 1 wherein said analytical measurement comprises:
reliability of at least one of the following:
routes, gateways or location servers.

4. The communication system of claim 1 wherein said analytical measurement comprises:
announcement of the most newly added routes from the list consisting of:
gateways or location servers.

5. The communication system of claim 1 wherein said analytical measurement comprises:
rate of route additions for the list consisting of:
gateways or location servers.

6. The communication system of claim 1 wherein said analytical measurement comprises:
announcement of the most newly added routes from the list consisting of:
gateway or location servers.

7. The communication system of claim 1 wherein said analytical measurement comprises:
rate of route removals for the list consisting of:
gateways or location servers.

8. A method for determining routing availability in a combined circuit-switched/packet telecommunications network, said method comprising:
bi-directionally communicating TRIP data between location servers in different ITADs, said communication occurring as a result of a peering session being established between said location servers;
within at least one of said ITADs establishing a uni-directional peering session with a separate location server such that said separate location server stores TRIP data communicated between said ITADs during said bi-directional peering session;
time stamping said TRIP data; and
communicating said time dated TRIP data to a control system for subsequent processing to determine said routing.

9. The method of claim 8 wherein said routing is determined by analytical measurements which comprise:
availability/unavailability of at least one of the following:
routes, gateways or location servers.

10. The method of claim 8 wherein said routing is determined by analytical measurements which comprise:
reliability of at least one of the following:
routes, gateways or location servers.

11. The method of claim 8 wherein said routing is determined by analytical measurements which comprise:
announcement of the most newly added routes from the list consisting of: gateways or location servers.

12. The method of claim 8 wherein said routing is determined by analytical measurements which comprise:
rate of route additions for the list consisting of:
gateways or location servers.

13. The method of claim 8 wherein said routing is determined by analytical measurements which comprise:
announcement of the most removed routes from the list consisting of:
gateway or location servers.

14. The method of claim 8 wherein said routing is determined by analytical measurements which comprise:
rate of route removals for the list consisting of:
gateways or location servers.

15. An ITAD comprising:
a first location server for bi-directionally communicating with at least one other ITAD the reachability of telephony destinations, attributes associated with said destinations and the attributes of the paths toward said destinations;
a second location server for storing therein copies of said data pertaining to telephony destinations, attributes associated with said destinations, and attributes of the paths toward said destinations, said second location server uni-directionally communicating with said first location server; and
a processor for time stamping data received by said second location server such that at least one system parameter can be generated pertaining to at least one of the following:
currently available routing; and
currently available location servers.

16. The ITAD of claim 15 wherein both said bi-directional and uni-directional communication employ the Telephony Routing Information Protocol (TRIP) operating in peering sessions.

17. A system for monitoring network routing availability in a combined circuit-switched/packet telecommunication network, said system comprising:
means for bi-directionally communicating TRIP data between location servers in different ITADs, said communication occurring as a result of a peering session being established between said location servers;
means within at least one of said ITADs for establishing a uni-directional peering session with a separate location server such that said separate location server stores TRIP data communicated between said ITADs during said bi-directional peering session; and
means for communicating said TRIP data from said separate location server to a control system for subsequent processing to determine at least one of the following:
which location server in the system is the most reliable;
which location server in the system is announcing the most routes;
which location server in the system is removing the most routes;
which routes have been added and when;
which routes have been removed and when;
currently available routing;
historically available routing; and
statistical data on past routing availability on a time basis.

18. The system for claim 17 further comprising:
means for time stamping said data from said separate location server prior to communicating said data to said control system.

19. The system for claim 18 wherein said uni-directionally peering causes said separate location server to become a repository of both internal network routing data and external network routing data, said main location server operable for peering with all other location servers within said ITAD to collect network routing data from and to deliver network routing data to said other internal location servers and operable for peering with a main location server in at least one other ITAD for interchanging with said peered server network routing data.

20. A method of operating a location server at an ITAD, said method comprising:
uni-directionally peering with a main location server within said ITAD such that a repository of both internal network routing data and external network routing data is created; said main location server operable for peering with all other location servers within said ITAD to collect network routing data from and to deliver network routing data to said other internal location servers and operable for peering with a main location server in at least one other ITAD for interchanging with said peered server network routing data; and
generating from said repository of network routing data at least one system parameter selected from the list of:
which location server in the system is the most reliable;
which location server in the system is announcing the most routes;
which location server in the system is removing the most routes;
which routes have been added and when;
which routes have been removed and when;
currently available routing;
historically available routing;
statistical data on past routing availability on a time basis;
rate of route additions per gateway;
rate of route additions per location server;
rate of route additions per gateway; and
rate of route removals per location server.

21. The method of claim 20 further comprising:
communicating generated ones of said parameters to a location external to said ITAD.

22. The method of claim 20 further comprising:
time-stamping said data in said repository of network routing data prior to said parameter generating.

23. The method of claim 22 further comprising:
communicating said time stamped data to a location external to said ITAD prior to said generating.
